(19) United States
(12) Patent Application Publication
(10) Pub. No.: US 2020/0042552 A1
(43) Pub. Date: Feb. 6, 2020

(54) DISTRIBUTED RECORDING, CURATION, AND TRANSMISSION SYSTEM FOR CONTEXT-SPECIFIC CONCATENATED MEDIA GENERATION

(71) Applicant: Kevin D. Mayes, Austin, TX (US)

(72) Inventor: Kevin D. Mayes, Austin, TX (US)

(21) Appl. No.: 16/530,541

(22) Filed: Aug. 2, 2019

Related U.S. Application Data
(60) Provisional application No. 62/713,992, filed on Aug. 2, 2018.

(51) Int. Cl. G06F 16/635; G11B 27/031; G11B 27/11; G06F 16/64; G06F 16/68

(52) U.S. Cl. CPC G06F 16/637; G11B 27/031; G06F 16/68; G06F 16/64; G11B 27/11

(57) ABSTRACT

A system and method for the automatic sequencing and concatenation of media selections to create a personalized electronic greeting card. Snippets of audio, video and other types of media from a variety of sources may be automatically selected, assembled, and mixed together to create a unique greeting message that is recorded for subsequent delivery to a recipient.

### CROSS-REFERENCE TO RELATED APPLICATIONS

This application claims the benefit of U.S. Provisional Application Ser. No. 62/713,992, titled “Distributed Recording, Curation, and Transmission System for Context-Specific Concatenated Media Generation,” filed by Kevin D. Mayes, on Aug. 2, 2018, the entire contents of which is incorporated herein by reference.

### TECHNICAL FIELD

Various embodiments relate generally to computer-implemented methods for receiving emotional support from a person's friends, family, and/or acquaintances.

### BACKGROUND

At various times during a person's life, the person may go through a hardship or be isolated from people that they love and care about. For example, a person serving in the military may be deployed overseas for lengthy periods of time thousands of miles away from their family. For individuals that are incarcerated in a prison for years, it may be difficult to have regular emotional contact with their friends and family. People hospitalized with debilitating health issues may be far away from their relatives, which may make it very difficult for relatives to visit the hospital due to the lengthy travel times.

Computer systems and networks, such as the Internet, may allow people to communicate over long distances. For example, a friend may call another friend who has moved to another country to discuss recent events experienced by either friend. A mother may post of photograph of a family pet on a social networking site, along with a comment, which may allow the mother's children to “check-in” on the family pet. In some situations, a romantic couple engaged in a long-distance relationship may have a “video call” where each partner in the couple is able to see the other partner's facial expressions in real-time.

### SUMMARY

Apparatus and associated methods relate to a distributed recording, curation, and transmission (RCT) system configured to coordinate support messages for a context-specific life event, curate the support messages into a concatenated media file, and transmit the concatenated media file to a person experiencing the life event. In an illustrative example, a person may be hospitalized for a life-threatening injury, and may benefit from hearing words of encouragement from their friends, family, loved ones, and acquaintances. The RCT system may send recording requests initiated by an organizer to friends/family directing them to record context-specific messages that are tailored to provide emotional support and words of encouragement to the person. The RCT system may then collect, curate, mix, and/or concatenate the individual recorded messages into a media file. The RCT system may then transmit the media file to a recipient, which may advantageously provide encouragement and support to aid their recovery.

Various embodiments may achieve one or more advantages. An RCT system may significantly lower the effort and time required to disseminate recording requests, collect and store recordings, curate recordings into a combined media file, and to transmit the combined media file to a recipient. An organizer may quickly input in a list of recording persons and at the click of a button, send off numerous invitations to senders requesting that they record a message for the recipient. The RCT system may then automatically (1) collect the recordings, and (2) assemble the recordings together into a combined media file, which may drastically increase the speed at which a finalized media file containing the recordings is delivered to the recipient. The RCT system may advantageously perform various (automated) audio and/or video processing techniques to the recordings and combined media file that may optimize the combined media file for consumption by the recipient.

An organizer may beneficially select which modes of communication, contact, or delivery are most appropriate for each sender, focal person, and/or recipient. An organizer may automatically set a frequency of delivery for each finalized media file, so that the recipient may receive messages at (semi-)regular time intervals. The RCT system may advantageously provide significant guidance to friends/family on how to record proper, heartfelt, and non-offensive messages that are specifically tailored to the life event of the person experiencing difficulty. For example, a co-worker may be guided through a structured template containing multiple parts, which is occasion or event specific. An organizer may beneficially coordinate, customize, and control various aspects of recording, curation, and transmission.

In some examples, multiple people may pool their shared messages into a single powerful message that significantly raises the spirits of a person enduring the context-specific life event. Some embodiments may provide a computer system that enables the rallying of a group of people to provide support to a person experiencing hardship by creating a cumulative audio/video card that builds upon recorded messages by each person in the group in an episodic manner. An audio/video card may, for example, create energy and emotional support for the person experiencing hardship by communicating to that person that the group of people are behind them and care about them. An RCT system may perform a (semi-) automated, software-based, technological process that may take may audio/video clips, combine them together into a combined media file, and then send a finalized media file to the recipient, who may be the person experiencing hardship or difficulty. Some embodiments may give hope to people who are hospitalized, incarcerated, deployed overseas, or otherwise experiencing a trying and difficult life event.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a diagrammatic view of an exemplary distributed recording, curation, and transmission (RCT) system illustrating an exemplary use case.

FIG. 2 depicts a block diagram view of an exemplary RCT computer system and its connectivity to other networks and computing devices.

FIG. 3 depicts a user-interface view of an exemplary organizer dashboard.

FIG. 4A depicts a flowchart illustrating an exemplary process flow associated with operation of an RCT system.

FIG. 4B depicts a flowchart illustrating an exemplary process flow associated with operation of an RCT system.

Like reference symbols in the various drawings indicate like elements.

### DETAILED DESCRIPTION OF ILLUSTRATIVE EMBODIMENTS

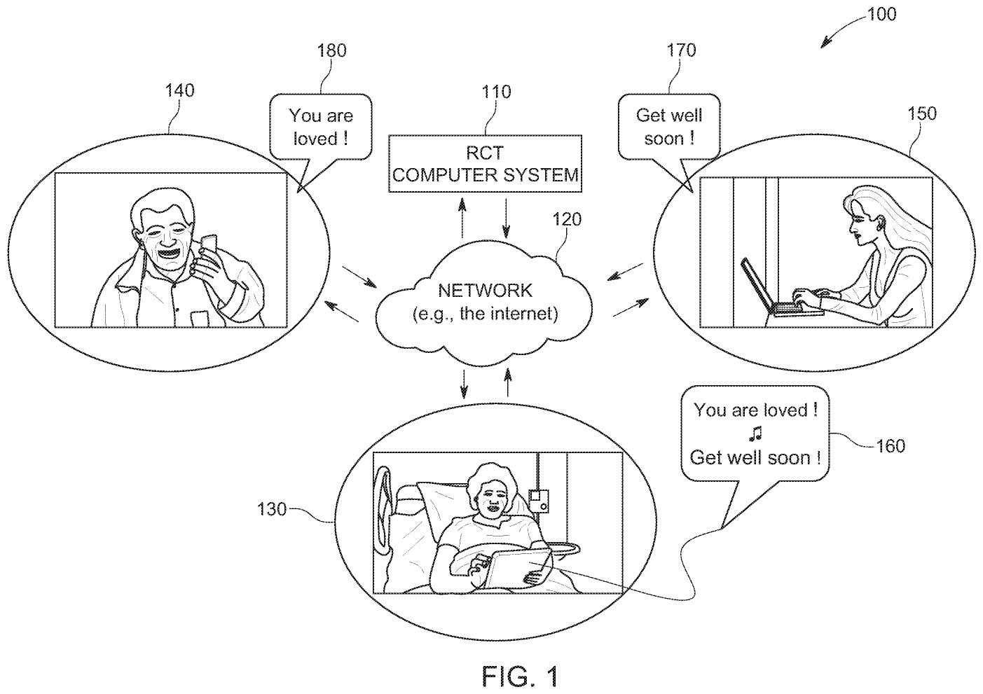

FIG. 1 depicts a diagrammatic view 100 of an exemplary distributed recording, curation, and transmission (RCT) system 110 illustrating an exemplary use case. A use case starts with a focal person being hospitalized for a debilitating illness 130 (center bottom). An organizer (not shown) has created an account with the RCT system 110 to collect and organize recordings from multiple people (“recording persons”) who may be friends, family, or acquaintances of the focal person. After receiving the list of these recording persons, the RCT system 110 sends out invite messages (e.g., via a network such as the Internet) to each recording person requesting that they record a heartfelt message for the focal person.

In response to receiving these invites, each recording person records their own personalized message for the focal person, with each message being specifically tailored to the context of the difficult life event the focal person is experiencing (in this case, being hospitalized for a debilitating illness). In the exemplary depiction in FIG. 1, the focal person's father 140 (top left) may record a voice message 180 (a first message) saying “You are loved!” 160 while the focal person's co-worker 150 (top right) may record a voice and video message (a second message) saying “Get well soon!” 170 with a video of the co-worker smiling and waving. These messages are collected by the RCT system 110 (e.g., via a network such as the Internet 120), and then curated, mixed, concatenated, and/or otherwise processed to generate a media file for consumption by the focal person.

After generation of the media file, the RCT system 110 transmits (e.g., via a network such as the Internet 120), the media file to the focal person for consumption by the focal person. In this case the media file includes the first and second recorded messages concatenated together (“You are loved! 160 Get well soon! 170”), along with mixed music. In response to receiving this media message, the focal person may experience positive feelings and emotions such as joy, hope, cheerfulness, pleasant surprise, confidence, enthusiasm, inspiration, contentment, security, and love, which may advantageously aid the focal person in handling, persevering through, and overcoming their difficult life event.

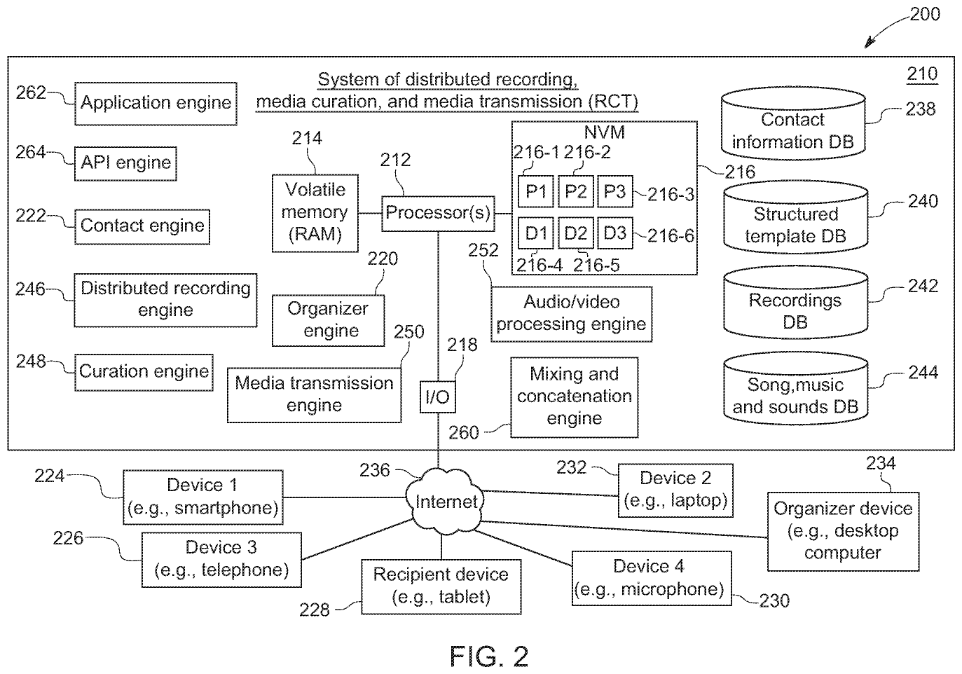

FIG. 2 depicts a block diagram view 200 of an exemplary RCT computer system and its connectivity to other networks and computing devices. An RCT system 210 includes one or more processors 212, volatile memory (e.g., RAM) 214, non-volatile memory (NVM) 216, and input/output (I/O) 218. Stored in NVM 216 are various programs P1 216-1, P2 216-2, P3, 216-3 along with data and data structures D1 216-4, D2 216-5, D3 216-6. At least one processor 212 may execute functions in accordance with the programs P1-P3 216-1-216-3 that utilize the data D1-D3 216-4-216-6 to accomplish various functions and objectives of the RCT system 210. The RCT system I/O 218 may transmit and/or receive data from other devices over a network (e.g., the Internet 236).

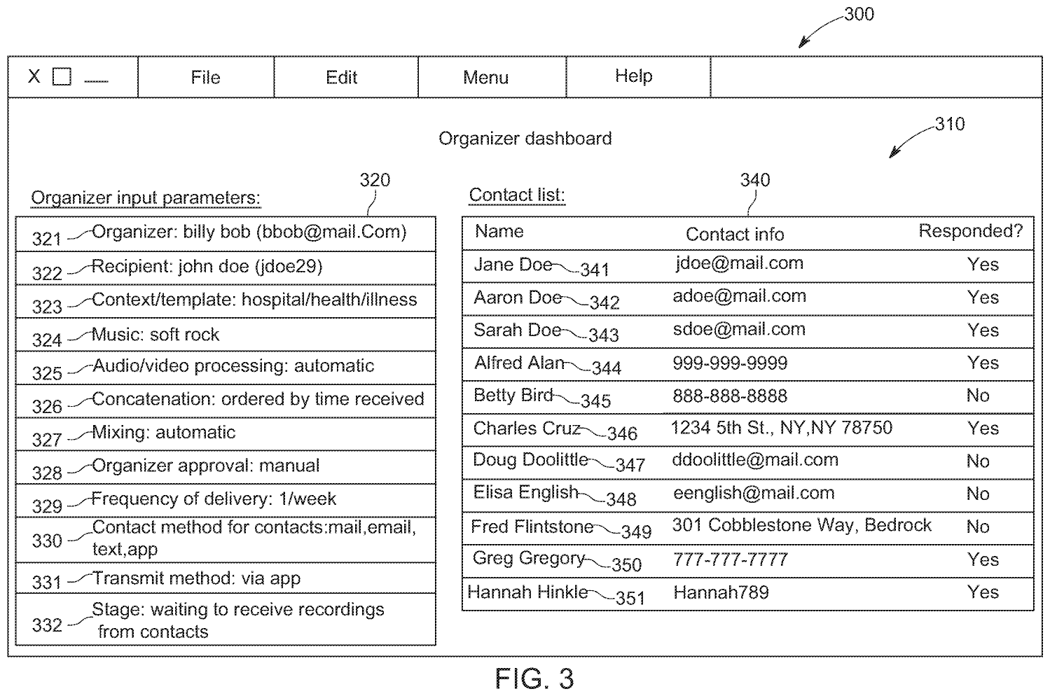

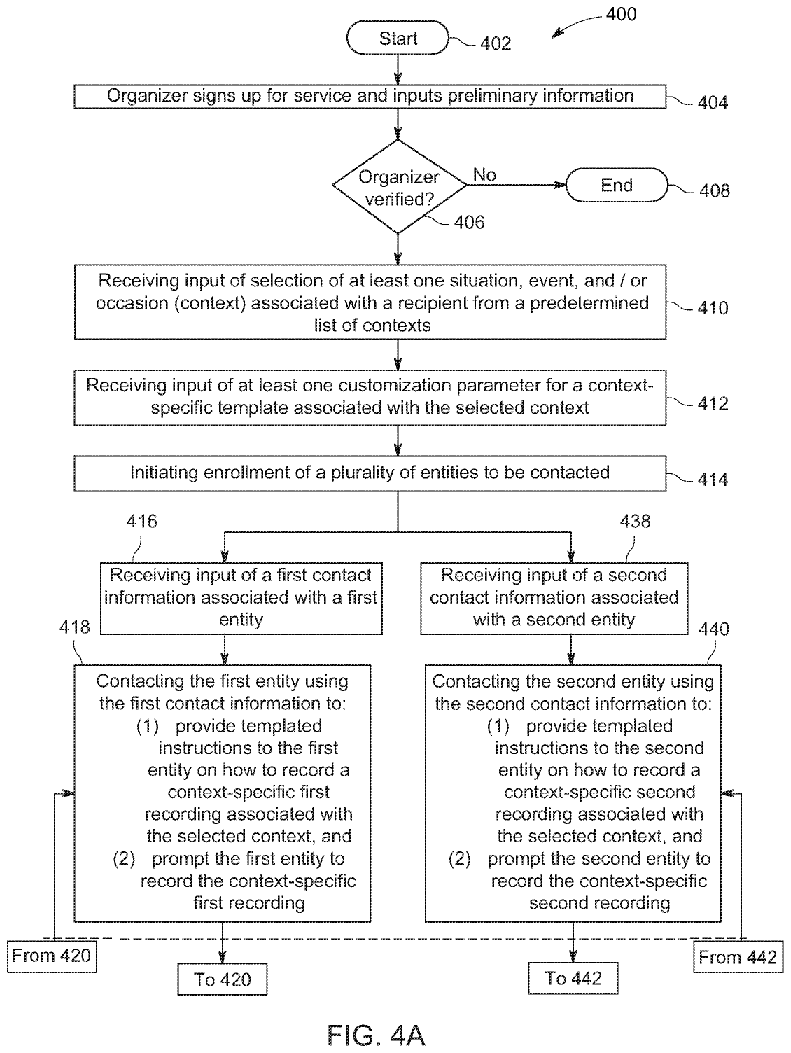

In this illustrative embodiment, an organizer engine is configured to perform various functions associated with organizing, directing, and coordinating the various steps and functions of the RCT system 210. For example, the organizer engine may include an organizer account system that allows an organizer (via the organizer's electronic device, such as a desktop computer 234) to create and set up an account associated with a specific focal person. The organizer engine may provide an interface to the organizer (e.g., the organizer dashboard 310 of FIG. 3 described further below) that allows them to set different parameters and customizations, such as the identity of the focal person, a list of recording persons, the life-event-specific context associated with the focal person, and the medium through which the media file will be sent to the focal person.

A contact engine 222 sends contact messages to a group of two or more recording persons (via the various electronic devices of each recording person) to invite them to record a customized message for the focal person. In some examples, the contact engine 222 may send a notice to the recording persons apprising them of the specific context of the life event that the focal person is experiencing, along with instructions that instruct them on how to record a proper message for the focal person (e.g., a recorded message that is tailored to the specific context of the life event of the focal person).

The contact engine 222 may have access to a contact information database (DB) 238 that contains a list of contacts associated with the focal person. For example, the contact information database 238 may be a relational database (e.g., SQL database) where each row contains information about a recording person (e.g., their name, email, phone number), along with the name of an associated organizer and the name of the focal person. Upon direction by an organizer, the contact engine 222 may pull the information for each recording person associated with a given focal person from the contact information DB 238, and send each recording person an (electronic) message inviting them to record a heartfelt message for the focal person.

The contact engine 222 may send messages destined for the devices of each recording person. For example, a first recording person may have a smartphone 224, a second recording person may have a laptop 232, and a third recording person may have a telephone 226. The contact engine 222 may send a text message to the number associated with the smartphone 224 of the first recording person, send a message to the email address of the second recording person (which may be received on the second person's laptop 232), and a voice message to the telephone number associated with the telephone of the third person. These messages may include, for example, a link to a webpage or voice walkthrough that gives each recording person the ability to record a customized message for the focal person. In some examples, the message may include a structured template that guides each recording person through instructions teaching them how to record a message that is tailored to the specific occasion or event of the focal person.

The type of structured template given to each recording person may be based on the specific (life) event, occasion, situation, or context being experienced by the focal person. In some examples, the organizer may select the type of event, occasion, situation, or context from a predefined/predetermined list. For example, the predefined/predetermined context list may include items such as: hospitalization, military deployment, incarceration, divorce, child custody dispute, death of a close family member, a miscarriage, or illness. These types of items may be “negative.” In some examples, a predefined list may include “positive” items, for example, a marriage, birth of a healthy child, graduation, starting a new job, or moving into a new house. In various embodiments, a predefined list may include “neutral” items. A collection of predefined structured templates may be stored in structured template database (DB) 240. In some examples, after an organizer selects one or more contextual items associated with the focal person (e.g., via a user interface provided by the RCT system), the RCT system 210 may pull (an) associated structured template(s) from the structured template DB 240, and send the template to each recording person. This may give each recording person information and instruction to record a unique message that is customized and tailored to the specific (life) event, occasion, situation, or context being experienced by the focal person.

In an illustrative example, the organizer may select from the predefined list of contexts “incarceration.” Then, after the organizer has approved the list of recording persons, the RCT system 210 may send a message to each recording person that includes an instructional template specifically geared to the incarceration of the specific focal person. The incarceration structured template may contain instructions such as: (1) “give encouraging messages to the incarcerated person,” (2) “don't say the words ‘prison’ or ‘incarceration’ in your recorded message,” and (3) “you may want to suggest mentioning how you can't wait to see the person when they are freed.”

A distributed recording engine 246 enables recording persons to record a custom message for the focal person. For example, after receiving a message sent by the contact engine 222, each recording person may be presented with an interface that allows them to record a message for the focal person. The distributed recording engine 246 may receive data associated with these individual recordings and may store each recording in a recordings database (DB) 242. In this sense, the distributed recording engine 246 may distribute the recording of messages to each individual recording person, receive each recording, and store each recording in a recordings DB 242. In an illustrative example, recording persons 1-4 may have different recording devices 1-4 (e.g., smartphone 224, laptop 232, telephone 226, microphone 230), which may all be used to record messages to be received by the distributed recording engine 246.

An audio/video (A/V) processing engine 252 performs various audio and/or video processing functions on a various media files. For example, if a recorded message contains significant background noise or distortion, the A/V processing engine 252 may remove this noise or distortion. In some embodiments, if a recorded message contains a video file with extremely high or low luminance values, the A/V processing engine 252 may perform gamma correction on the video file. In various examples, the A/V processing engine 252 may parse various media files to extract portions or snippets of a given recording. In some embodiments, the A/V processing engine 252 may perform speech recognition or speech-to-text operations, such that a text file associated with a recording may be algorithmically parsed or processed. The A/V processing engine 252, in some examples, may flag or filter out undesirable speech or words such as curse words, offensive words, or words that are not recommended given the specific context, event, situation, or occasion.

More generally, the A/V processing engine 252 may perform audio or video processing functions that are known in the art of audio or video processing (e.g., audio—equalization, pitch shift, filtering, applying effects such as echo/flanger/reverb; e.g., video—contrast, motion compensation, aspect ratio control, detail enhancement, video artifact reduction). Various functions of the A/V processing engine 252 may be automatic (e.g., algorithmically implemented) or manual (e.g., implemented by an audio/visual processing technician).

A mixing and concatenation (M/C) engine 260 performs mixing and concatenation functions on various media files. For example, the M/C engine 260 may concatenate multiple recordings together into a combined media file. In some embodiments, the M/C engine 260 may mix songs, music, or sounds into a combined media file along with recording files retrieved from the recordings DB 242. The M/C engine 260 may retrieve these songs, music, or sounds from a song, music, and sounds database (DB) 244.

In various examples, the M/C engine 260 may include an algorithm that allows for automatic concatenation of multiple recorded files into a combined media file. The algorithm may, for example, place the recorded files in an order corresponding to the order in which they were received by the distributed recording engine DB 246 and recordings DB 242. In some embodiments, the algorithm may place the recorded files in a randomized order.

The M/C engine 260 may perform various audio and/or video processing functions to create a media file. For example, the M/C engine 260 may incorporate the functions of the A/V engine 252. In some embodiments, the M/C engine 260 may balance the audio level of the different recording files so that the voice level of each recording person is at substantially the same decibel level (e.g., within 1, 5, 10, or up to about 20 percent average/minimum/maximum of each other). The M/C engine 260 may, for example, add timing space between each recorded message in a combined media file.

Some embodiments may permit the M/C engine 260 to extract a commonly used message from different recording files, and overlap each common message into a combined, substantially synchronous or sequential message. For example, a structured template may instruct each recording person to say the common message of “We love you!” at the end of their message. The A/V engine 252 may perform voice recognition processing on each recording file in the recording DB 242 to identify the exact instant each recording person said the common message of “We love you!” The M/C engine 260 may then combine each extract each instance of the common message from the individual recordings and combine each common message together in a media file for consumption by the focal person. Such a media file may include a section where all instances of the common message “We love you!” are played synchronously (in unison) or sequentially (one after the other). In various examples, audio and video of each recording person saying the common message of “We love you!” may be combined synchronously or sequentially in a media file for consumption by the focal person (e.g., like the grid layout showing the cast members from the “Brady Bunch” TV show). Combining a common message may advantageously provide the focal person with powerful emotional encouragement, support, or inspiration that may be therapeutic given the specific context, situation, occasion, or event the focal person is experiencing.

A curation engine 248 performs various curation functions on media files. For example, the functions of the A/V engine 252 and/or the M/C engine 260 may be included with the curation engine 248. The curation engine 248 may organize, pull together, sift through, and/or select for presentation various content or media files. For example, the curation engine 248 may collect the various outputs of the A/V engine 252 and the M/C engine 260 and combine them into a finalized media file for consumption by the focal person. The curation engine 248, in some embodiments, may prepare the finalized media file, along with other items, to be sent to the focal person.

A media transmission engine 250 is configured to transmit the finalized media file to the focal person (via, for example, a recipient device, such as a tablet computer 228, associated with the focal person) for final consumption by the focal person. The media transmission engine 250 may send the finalized media file to the device or the focal person by various methods (e.g., email, text, voicemail, voice chat). If the media transmission engine 250 notices that the finalized media file has not been accessed by the focal person after a certain period of time, the media transmission engine 250 may attempt to resend the finalized media file, or may contact the organizer to apprise them that the finalized media file has yet to be opened by the focal person. In some embodiments, the media transmission engine 250 may be configured to send multiple media files to the focal person at regular, predefined, periodic, or dynamic intervals.

An application engine 262 powers functions of an application installed on the electronic device of a recording person or a focal person. For example, a recording or focal person might download an application program (APP) and install it on their device (e.g., a smartphone 224). The application engine 262 may provide the “back end” for the various functions and features of the APP. As an illustrative example, an organizer may set up an account and input various information into the RCT system 210 via an APP, a recording person may record a message via an APP, while a focal person may receive a finalized media file via an APP.

An application programming interface (API) engine 264 allows programmers to write computer code to interface with the various data, functions, and aspects of the RCT system 210. For example, the API engine 264 may allow for a third-party application to interface with the various engines and databases of the RCT system 210. In some examples, the API engine 264 may power the various functions of, or be the “back end” for, the APP program.

FIG. 3 depicts a user-interface view 300 of an exemplary organizer dashboard. The organizer dashboard 310 may, for example, be powered by software or programming installed on an electronic device. In some embodiments, the organizer dashboard is a webpage that is supported by a server and the RCT system 210. The organizer dashboard may be powered, at least in part, by the API engine 264 of the RCT system 210 (FIG. 2). The organizer dashboard shows various information used by the RCT system 210 to perform recording, curation, and transmission operations. Some of the information may be input by the organizer using the organizer's electronic device (e.g., mutable), while other information may not be changed by the organizer (e.g., immutable).

In an illustrative example, an organizer signs up and creates an account with the RCT system 210. The organizer may input and/or alter at least one or more of the following pieces of organizer input parameters 320 or information:
Organizer's name and contact information 321 (e.g., Billy Bob and bbob@mail.com)
Recipient's (focal person's) name and contact information 322 (e.g., John Doe; e.g., APP username: JDOE29)
   Here, the focal person is using the APP on their electronic device, and has a username through which they can receive messages from the RCT system.
Context/situation/event/occasion/template 323 (e.g., hospital/health/illness)
Music 324 (e.g., soft rock)
Audio/Video Processing 325 (e.g., automatic)
Concatenation (e.g., ordered by time received)
Organizer Approval 328 (e.g., manual)
   Here, the organizer has indicated that they must approve the final media file before it is transmitted to the focal person.
Frequency of Delivery 329 (e.g., 1/week)
   Here, the organizer has indicated that they want reoccurring messages to be sent to the focal person.
Contact Method for Contacts 330 (e.g., mail, email, text, app)
Transmit Method 331 (to recipient/focal person) (e.g., via app)
Stage 332 (e.g., waiting to receive all recordings from contacts/recording persons)
Contact List 340 (e.g., Jane 341 through Hannah 351)

In the illustrative embodiment of FIG. 3, John Doe is in the hospital for a back injury. Organizer Billy Bob has decided to help John Doe feel better during his recovery by sending encouraging messages from John Doe's friends/family/acquaintances using the RCT system. Billy Bob has selected the context and structured template from a predefined list, in this case, the context of hospitalization or illness. Billy Bob has selected soft rock as being the background music for the finalized media file, automatic audio/video processing of recorded messages and media files, concatenation of recorded messages by order received, automatic mixing of recordings and sounds, organizer approval required before transmission of the finalized media file, reoccurring delivery of 1/week, the various contact methods for contacts, and the transmission method for transmitting the finalized media file to the focal person.

Billy Bob has also filled in the list of contacts (recording persons) who will be recording heartfelt messages for John Doe. In this example, John's family (Jane 341, Aaron 342, and Sarah Doe 343) and John's friends/acquaintances (Alfred 344 through Hannah 351) are selected as the recording persons. Each recording person will be contacted via a specific contact method/information to perform the recording of their message for John. In this illustrative example, Jane 341, Aaron 342, Sarah 343, Doug 347, and Elisa 348, will all be contacted through email; Alfred 344, Betty, 345 and Greg 350 will be contacted via telephone, and Charles 346 and Fred 349 will be contacted through regular mail (e.g., with a non-transitory memory device, such as a CD or memory/USB stick, to which they can write their recordings).

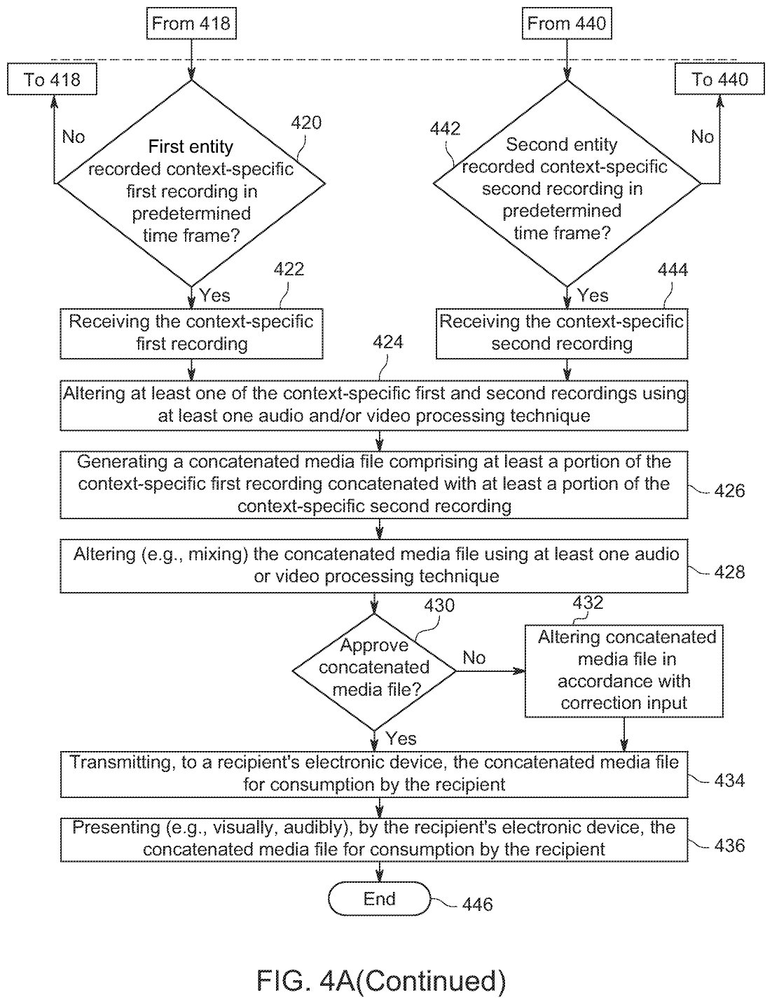

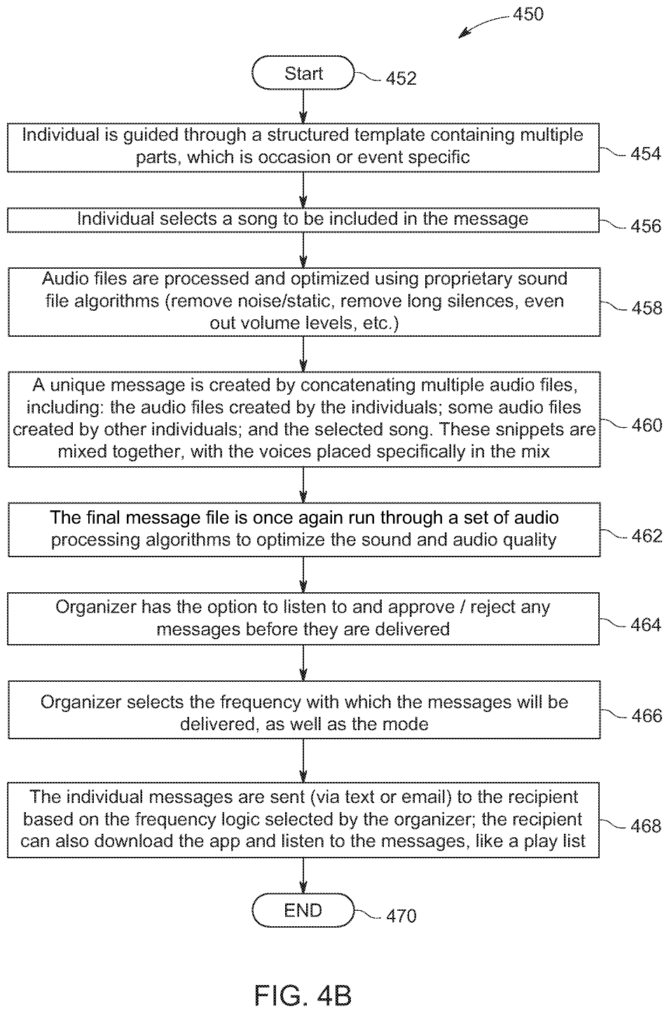

FIG. 4A depicts a flowchart 400 illustrating an exemplary process flow associated with operation of an RCT system. Various steps of a process flow may be optional (not required), reordered, and/or repeated. A process flow starts 402 with an organizer signing up and creating an account with the RCT system by inputting preliminary information (such as, for example, the organizer's name, the focal person's name, and contact information) 404. At 406, the RCT system then sends a verification message to the contact address associated with the organizer to verify the identity of the organizer. If the organizer is not verified, the process ends 408. If the organizer is verified, the process continues at 410 to the RCT system receiving input of selection of at least one situation, event, and/or occasion (context) associated with a recipient from a predetermined list of contexts. As noted above, potential items selectable from this predetermined list of contexts may include hospitalization, military deployment, and incarceration.

Next, at 412 the RCT system receives input of at least one customization parameter for a context-specific template associated with the selected context. In an illustrative example, an organizer selects “military deployment” from the predetermined list of contexts. In the structured template DB of the RCT system, a context-specific template associated with “military deployment” is retrieved. The organizer may then customize at least one parameter of the retrieved context-specific template. For example, the organizer may set parameters indicating that the military branch of the focal person is “navy,” that the gender of the focal person is “male,” and that the deployment time will be “6 months.” In response, the context-specific template will be adjusted to customize the templated instructions provided to each recording person so that each customization parameter is included in the templated instructions.

Next at 414, the RCT system initiates enrollment of a plurality of entities to be contacted (e.g., recording persons). The RCT system receives at 416 input (e.g., from the organizer) of a first contact information (e.g., email, phone number, address) associated with first entity (e.g., a first recording person). The RCT system then contacts the first entity using the first contact information to: (1) provide templated instructions (associated with the retrieved context-specific template) to the first entity on how to record a context-specific first recording associated with the selected context-specific template, and/or (2) prompt the first entity to record the context-specific first recording 418. Next, the RCT system checks to see whether the first entity has recorded the context-specific first recording in predetermined time frame 420. If no, then the RCT system contacts the first entity using the first contact information again at 418. If yes, then at 422 the RCT system receives the context-specific first recording.

The RCT system performs similar operations for a second entity (e.g., receiving contact information 438, contacting 440, recording the context-specific second recording 442 and receiving the context-specific recording 444). The RCT system may also perform similar operations for a third, fourth, fifth, etc. entity (e.g., a finite number of entities/recording persons). For example, a first entity may be a relative of the focal person, a second entity may be a close friend of the focal person, a third entity may be a co-worker of the focal person, etc.

After at least two context specific recordings have been received by the RCT system, the RCT system at 424 then alters at least one of the context-specific first and second recordings using at least one audio and/or video processing technique (e.g., using A/V engine shown in FIG. 2). In some examples, only one context specific recording may be received by the RCT system, which may then be altered using at least one audio and/or video processing technique. Such a situation may happen, for example, for a first message that is to be sent to the recipient (as described further below). Next, at 426, the RCT system generates a concatenated media file (e.g., using A/V and/or M/C engine shown in FIG. 2) that includes at least a portion of the context-specific first recording concatenated with at least a portion of the context-specific second recording. Next, at 428, the RCT system alters the concatenated media file using at least one audio or video processing technique (e.g., using A/V, M/C, or curation engine shown in FIG. 2). In the example where only one context specific recording is received by the RCT system (e.g., for the first message to be sent to the recipient), the RCT system may not perform the concatenation steps. In some embodiments, only messages sent to the recipient after the first message may include this concatenation step. So, for the first message, the steps of concatenating two or more recordings together into a single media file may not be executed by the RCT system, but rather may only be executed for the second and subsequent recordings following the first recording.

After this, at 430, the RCT system prompts (e.g., an organizer) for approval of the (altered) concatenated media file. If the file is not approved, then the RCT system alters the concatenated media file in accordance with correction input (e.g., from the organizer) 432. For example, the organizer might hear a curse word or an otherwise unpleasant recording from one of the recording persons that may not belong in the finalized media file that may be consumed by the focal person. In this event, the organizer may (e.g., via the organizer dashboard), excise the unwanted language from the concatenated media file before it is transmitted to the focal person.

If the file is approved 430, then the RCT system transmits, to a recipient's (focal person's) electronic device, the (approved/altered)) concatenated media file for consumption by the recipient 434. Finally, at 436, the (approved/altered) concatenated media file is presented (e.g., visually, audibly) by the recipient's electronic device for consumption by the recipient. The process flow then ends at 446 with the recipient (focal person) being encouraged, inspired, and reinvigorated by hearing (and/or visualizing) heartfelt messages from their friends and family, thus giving the focal person increased hope, joy, and cheerfulness knowing that so many people care about and support them.

In some examples, the RCT system may transmit a first message to the recipient with just a single recorded message from a single recording person. For example, the first message sent to the recipient may have only one voice of a first recording person (e.g., it may not require two different voices from two different recording persons). Therefore, the steps shown in FIG. may not branch out after the step of “Initiating enrollment of a plurality of entities to be contacted,” at least for the first message sent to the recipient. For subsequent messages, after the first message with just a single voice, may use the context-specific recordings of multiple persons.

For example, the branch in FIG. 4A may occur asynchronously, to where a first recording person records a first message at a first time, and the second recording person records a second message at a second time. In some examples, multiple voices in a transmitted message may only occur after the first message has been sent having the voice of just one recording person. In subsequent messages after the first message, each message may build off of the previous message, in a cumulative or “snowballing” fashion. Therefore, there may be separate audio files for each recording person, such that the first message may include parts of the first audio file, the second message may include parts of the first and second audio files, the third message may include parts of the first, second, and third audio files . . . etc. In this sense, the recipient may beneficially receive the cumulative positive impact of having messages sent at (regular) intervals that continually build up the spirits of the recipient.

Various steps in the process flows FIGS. 4A and 4B may, for example, be optional/not required, modified/altered, or performed in a different order (at least for the first recorded message). For example, after the “Initiating enrollment of a plurality of entities to be contacted” step, only a single branch of the (e.g., just contacting the first entity) may be performed to generate the first message for the recipient. The step of “Generating a concatenated media file comprising at least a portion of the context-specific first recording concatenated with at least a portion of the context-specific second recording” may not be performed, at least for the first message prepared for the recipient, as the first message may only have the voice of the first recording person. Therefore, the step of concatenating two recording files together may not be performed for the first message. However, the concatenation of two recorded messages may be performed for subsequent messages following the first message. So for the first message, instead of the concatenated media file, an altered/mixed media file that is not concatenated with other recordings from other recording persons may be transmitted (e.g., a medial file that just has the single recording from the first recording person without concatenated recordings of other persons). For subsequent messages however, various parts of preceding messages may be stitched together with a new recording from the next recording person to cumulatively build a heartfelt message from the friends, family, and acquaintances of the recipient. In some examples, the steps in the branch of FIG. 4A may be performed, but the actual concatenation of parts from multiple recordings may only be performed for messages after the first message.

FIG. 4B depicts a flowchart 460 illustrating an exemplary process flow associated with operation of an RCT system. A (pre-)process flow may start at 452 with an organizer entering in contact information (email, phone, etc.) into the RCT system. The RCT system may then contact individuals (e.g., recording persons) on how to record their message. Next, an individual (e.g., recording person) creates an audio/video message for a recipient (e.g., focal person).

The process flow then continues at 454 with the individual being guided through a structured template containing multiple parts, which is occasion or event specific. Next, at 456, the individual selects a song to be included in the message. Next, at 458, the audio/video files are processed and optimized using proprietary sound file algorithms (e.g., to remove noise/static, remove long silences, even out volume levels, etc.). Next, at 460 a unique message is created by concatenating multiple audio/video files, which may include, for example, the audio/video files (snippets) created by the individuals; some audio/video files created by other individuals; and the selected song. These snippets are then mixed together into a final message file, with the voices placed specifically in the mix.

A final message file is once again run through a set of audio/video processing algorithms to optimize the sound/audio/video quality 462. Next, at 464 the organizer has the option to listen to and approve or reject messages before they are delivered. Next, at 466 the organizer selects the frequency with which the messages may be delivered, as well as the mode of delivery. Next, at 468 the individual messages are sent (via text or email, for example) to the recipient based on the frequency logic selected by the organizer. The process flow may then end at 470. In some examples, the recipient may download the app and listen to the messages (e.g., similar to a playlist). In some examples, at least some of the steps of the process flow detailed in FIG. 4A may be combined with at least some of the steps of the process flow detailed in FIG. 4B.

An audio card template provides for a predefined/predetermined structure for an audio card that may eventually be consumed by a recipient (focal person). The audio card template provides a sender (recording person) with instructions and a predefined structure for creating a recorded message tailored to the situation, context, event, or occasion associated with the focal person. An audio card assembly engine (which may be included as a (software) module with the RCT system shown in FIG. 2) may take the various parts of the recorded audio cards from different senders and combine them into a finalized media file destined for the recipient. An audio card recording platform/system may be used by a given sender to record the various audio sections in accordance with the audio card template. In some examples, the audio card recording platform/system may be a webpage or a feature of a software APP that may be loaded onto an electronic device of a sender. The audio card recording platform/system may include various selection options, display details, and user interface features that allow a sender to record the various sections of an audio card.

In an exemplary depiction, a template may have a one or more audio sections, each with a different type of message directed to the recipient. A sender may navigate to a webpage provided by the RCT system, which is the audio card recording platform. The sender may be provided with detailed instructions for how to adequately record the various messages corresponding to the different sections of the audio card template. In this exemplary depiction, the specific audio card template (perhaps selected by an organizer) has the specific context of “long hospitalization, non-religious.” In this case, the context may correspond to the hospitalization of the recipient for a broken ankle. Each sender (perhaps identified by the organizer using the contact list shown in FIG. 3) may record different sections of an audio card in accordance with the instructions, guidance, and direction of the audio card template.

In this example, a first audio section is directed to a recording of a “greeting and words of encouragement,” a second audio section is directed to an “aspirational message,” a third audio section is a “group message affirmation part 1,” a fourth audio section is a “group message affirmation part 2,” and a fifth audio section is “music selection.” The first two sections recorded by each sender may be concatenated together in a sequential fashion (e.g., by the M/C engine of FIG. 2), while the different “group message affirmations” recorded by each sender may be combined sequentially or in unison (e.g., by the M/C engine of FIG. 2). The song selected by the sender in the last audio section may be overlaid onto the other messages recorded by the sender in the finalized media file.

In another embodiment, the audio card assembly engine may retrieve the various audio sections recorded by the various senders, process them, and output at least one finalized audio card. The audio card assembly engine may process the various audio sections in different ways. For example, the engine may create a finalized audio card associated with the recordings of one or more senders. In some embodiments, the finalized audio cards may include combinations or permutations of the different audio sections recorded by the different senders. In the specific example shown, audio card #4 includes (sequentially) the first three sections of sender 4's recordings, the 3rd section of sender 3's recording, the 3rd section of sender 2's recording, and the 3rd section of sender 1's recording. At the end of the audio card #4 is every section 4 from all senders 1-4 combined (layered) in unison. Furthermore, the audio card #4 has the song selection from sender 4 playing in the background while the voice recordings are occurring. As noted on the left bottom side, various processing and combination functions may be performed by the audio card assembly engine to output a custom finalized media file (audio card) for consumption by the recipient.

In another embodiment, an exemplary process flow of an RCT system exists. A process starts with an organizer learning about the different aspects, benefits, and features of the RCT system (such as marketing copy, example audio cards, and video tutorials). Next, the organizer creates an account and signs up with an RCT system. The organizer may input various information into a form, for example, provided by the RCT system. This information may include the organizer's and recipient's (focal person's) name and contact information, a selection of the context associated with the recipient (and corresponding template), and payment information. The RCT system may then send an email to the organizer verifying the identity of the organizer.

Next, the organizer goes through an enrollment process, where the recording instructions are sent to the organizer, who then distributes the recording instructions (e.g., via email) to the various senders (recording persons). Next, the various senders record their audio messages and sections addressed to the recipient, with the help of templated instructions/suggestions and the structured template associated with the context of the recipient (e.g., military deployment). Next, the RCT system may receive/retrieve the audio files from the senders, download/retrieve the song/music chosen by a sender and perform various processing functions to generate a finalized audio card for consumption by the recipient. Next, a review process may include the organizer reviewing each audio section, audio card, and/or finalized audio card to approve/disapprove, and potentially make alterations or adjustments. In a final step, the RCT system sends the finalized audio card to the recipient (e.g., via text message). Optionally, the RCT system may share the finalized audio card to the senders.

In some examples, at least some of the steps of the process flow detailed in the various exemplary embodiments may be combined with at least some of the steps of the process flow detailed in FIG. 4A and/or FIG. 4B.

In some examples, the features, functions, and aspects disclosed herein may apply to audio and/or video. For example, an “audio card” may be an “video card” or an “audio/video card” where a sender records both audio and video data for consumption by the recipient. In some embodiments, the “audio card assembly engine” may be an “audio/video card assembly engine” configured to use the various components and sections of a recorded audio/video card. In various examples, an “audio card recording system/platform” may be an “audio/video card recording system/platform.”

Another embodiment may involve an exemplary instructional recording process flow, along with exemplary messages delivered to a recipient in a sequential, cumulative fashion. The instructional recording process flow may be an example of a set of templated instructions that guide a user through the process of making a context-specific recording specifically tailored to the situation of a focal person. A predetermined set of templated instructions may be delivered to a recording person that guide the recording person through steps to achieve the best quality recording that is specifically tailored to the specific context of the focal person/recipient. In this exemplary depiction, the process starts with a greeting that allows the recording person to get started with the recording process. The instructional guide then instructs the recording person on the specifics of making a recording. For example, the instructions may tell the recording person that there are five separate parts to the recording, specify what each part is, and prompt the person to record the message. These different parts of the recorded message may be sliced up and used in the concatenation step detailed in FIG. 4B. In some examples, the instructions may ask the person for which song they would like to use as background music in the final recorded message to be sent to the recipient/focal person. Lastly the instructions may confirm to the person that the process is complete and that a context-specific message will be sent to the recipient.

Exemplary messages may illustrate the aspect in which each sequential message builds upon the previous message in a cumulative fashion. In an illustrative example, Sender #1 (a first recording person) may have recorded a context-specific message that has been processed by the RCT system and sent to a recipient/focal person. A first message sent in this illustration only has the voice of Sender #1 (John). A second message sent in this illustration has the voices of both Sender #1 and Sender #2 (Carol), with a snippet of Sender #1's previous recording included at the tail end of the second message (Part 3b). A third message sent has the voices of Senders #1-3 (including Bill), which further builds upon the previous two messages by having snippers of Senders #1 and #2 voices included at the tail end of the third message (Parts 3b and 3c). A fourth message has the voices of Senders #1-4 (including Carl), which further builds upon the previous three messages by having snippers of Senders #1-3 voices included at the tail end of the third message (Parts 3b, 3c, and 3d). In each message that includes at least two voices, a part of the message includes the voices of all present and previous recording persons saying a common phrase in unison (e.g., “You are loved.”) In this sense, each subsequent message builds upon the previous message in a cumulative fashion, thus providing the recipient with positive emotional feelings knowing that so many people care about, support, and love them.

An exemplary message on Page 3 is the 7th message that mainly has the voice of a 7th recording person. In this example, the 7th message builds upon the previous 6 messages by including the voices of the previous 6 recording persons (e.g., recorded voices 1-6. As the end of the message is the voice of all 7 recording persons saying a common phrase in unison (e.g., “You are loved!”). This message also includes background music (e.g., chosen by the 7th recording person) that is playing in the background for at least part of the message duration. In this sense, this message has concatenated parts of various recordings that have sequentially built upon one another to create a series of heartfelt, and emotionally supportive words and phrases that aid the recipient/focal person in whatever life hardship they are currently experiencing.

Although various embodiments have been described with reference to the Figures, other embodiments are possible. For example, some embodiments of the RCT system may be implemented by a computer server (system) or on “the cloud.” Various data (e.g., recordings, songs, templates) may be stored on a “cloud server,” which may be accessible by a software program running on another computer server. In various examples, an RCT system may stitch together/concatenate various part of recordings from different senders into a cumulative/combined media file. Various steps of a process flow (e.g., FIGS. 4A, and 4B) may be optional (not required), reordered, and/or repeated.

In some embodiments, the RCT system may request multiple recordings and send multiple media files, potentially in a periodic, dynamic, or controlled fashion. For example, an RCT system may take recordings from multiple senders, combine some parts of the recordings into a first media file sent to a recipient at a first time, and combine other parts of the recordings into a second media file sent to a recipient at a second time. In various examples, the later sent media files may build upon earlier sent media files in a cumulative and progressive fashion to continually build confidence, motivation, and emotional support for the recipient in their time of need.

In some examples, the RCT system may include infrastructure that allows the recipient/focal person to respond to the senders after consuming the finalized media file/audio card. For example, if the recipient is using the APP powered by the RCT system, then the APP may allow for a bulk message to be sent from the recipient's electronic device to the various senders/recording persons. In some embodiments, if the recipient does not possess an electronic device (e.g., if the recipient is in prison), then the RCT system may still transmit the finalized media file to the recipient through another medium (e.g., via an 800 number that can be called by a prison guard).

Some functions of the RCT system may be available on a variety of electronic devices, such as desktop computers, mobile phones, or tablet devices. The interfaces provided by the RCT system may be web-hosted using a cloud-based computing platform (e.g., using Amazon Web Server (AWS)). The user interface provided to an organizer may indicate which contacts/recording persons/senders have responded with their recorded message(s) (e.g., right-most column of FIG. 3). The user interface provided to an organizer may indicate the current stage of the process.

In various embodiments, a structured template or context-specific template may determine the structure or nature of content in a combined media file and may also define the stitching order of each audio/video clip. In some examples, the finalized audio/video file may contain at least three different stages. A first stage may include sequentially played voices of the individual recording persons. A second stage may be a cumulative or reinforcing stage where quick, commonly worded snippets from each recording person is played back-to-back. A third stage may be a unison stage where a common message from every recording person is synchronized together and played in unison. In various examples, a mixing applied to an audio card may place the individual messages from each recording person in sequence like they are standing around the recipient (e.g., a stereo or surround sound audio configuration).

In some examples, the recipient may not be the same person as the focal person. For example, the recipient may be a different person from the focal person. In various embodiments, the recipient may be a close relative, family member, or friend of the focal person. For example, a wife may have a husband that has recently been deployed overseas. An organizer may input the name of the wife as a recipient on the organizer dashboard and may select a context of “military deployment—spouse of deployed.” A structured template may then be used for each recording person/sender that instructs them to record a message directed to the wife, but is concerned with the wife's difficulty of having their spouse deployed overseas. The template may, for example, instruct the senders to record words of encouragement saying that the wife's husband will be ok, he will be back home soon, and they can't wait to celebrate his return with the wife when he comes back from deployment. In another example, a mother may be the recipient, while the focal person may be her newly born baby that has been born with a handicap or birth defect. The senders may record messages directed to the mother by assuaging her worries about her child.

In some embodiments, a computer-implemented method may include receiving a first contact information associated with a first entity and receiving a second contact information associated with a second entity. The method may include contacting the first/second entity using the first/second contact information to: (1) provide templated instructions to the first/second entity on how to record a context-specific first/second recording, and (2) prompt the first/second entity to record the context-specific first/second recording. The method may include receiving the context-specific first/second recording. In response to receiving the recordings, the method may generate a concatenated media file comprising at least a portion of the context-specific first recording concatenated with at least a portion of the context-specific second recording. The method may transmit, to a recipient's electronic device, the concatenated media file for consumption by the recipient.

In some examples, the computer-implemented method may include, before generation of the concatenated media file, altering at least one of the context-specific first and second recordings using at least one audio processing technique. In various embodiments, computer-implemented method may include receiving user input indicating a specific context to be used for the context-specific first and second recordings.

Some aspects of embodiments may be implemented as a computer system. For example, various implementations may include digital and/or analog circuitry, computer hardware, firmware, software, or combinations thereof. Apparatus elements can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Some embodiments may be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example and not limitation, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits). In some embodiments, the processor and the member can be supplemented by, or incorporated in hardware programmable devices, such as FPGAs, for example.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. An exemplary embodiment may be implemented in a computer system that includes a graphical user interface and/or an Internet browser. To provide for interaction with a user, some implementations may be implemented on a computer having a display device, such as an LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from a source to a receiver over a dedicated physical link (e.g., fiber optic link, infrared link, ultrasonic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, FireWire, ATA/IDE, RS-232, RS-422, RS-485, 802.11 a/b/g/n, Wi-Fi, WiFi-Direct, Li-Fi, BlueTooth, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

In various embodiments, a computer system may include non-transitory memory. The memory may be connected to the one or more processors may be configured for encoding data and computer readable instructions, including processor executable program instructions. The data and computer readable instructions may be accessible to the one or more processors. The processor executable program instructions, when executed by the one or more processors, may cause the one or more processors to perform various operations.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A system for creating a custom electronic greeting card, comprising:
a database configured to store a collection of predefined structured context-specific media templates; and
one or more processors interfacing with the database and operative to:
select from the database one or more of the predefined structured context specific media templates;
enable a recording of one or more custom messages based on the one or more predefined context specific media templates; and
generate a concatenated media file from the recording of the one or more custom messages.

2. The system of claim 1, wherein the one or more processors are further operative to alter the recording of the one or more custom messages by executing one or more audio and video processing functions.

3. The system of claim 1, wherein the one or more processors are further operative to alter the concatenated media file by executing one or more audio and video processing functions.

4. The system of claim 1, wherein enabling a recording of one or more custom messages comprises:
recording by a first user a context-specific first recording; and
recording by a second user a context-specific second recording,
wherein the context-specific first recording and the context-specific second recording are recorded within a predetermined time frame.

5. The system of claim 4, wherein enabling a recording of one or more custom messages comprises recording individual context specific recordings by a plurality of different users.

6. The system of claim 3, further comprising:
an algorithm, executable by the one or more processors, including instructions to automatically concatenate the context-specific first recording and the context-specific second recording into a combined media file.

7. The system of claim 6, wherein the one or more audio and video processing functions include parsing a media file to extract snippets of a recording.

8. The system of claim 6, wherein the instructions to automatically concatenate include instructions to mix together songs, music, sounds, and recording files from the database.

9. The system of claim 6, further comprising a user interface configured by the one or more processors to:
enable a user selection from the collection of predefined structured context-specific media templates; and
customize a recorded message.

10. The system of claim 9, wherein the user interface is a dashboard that allows a setting of parameters to customize a media file.

11. A method of creating an electronic greeting card, comprising
enabling a recording of one or more custom messages based on one or more predefined context specific media templates stored in a database;
generating automatically a concatenated media file from the recording of one or more custom messages; and
altering the concatenated media file by executing one or more audio and video processing functions.

12. The method of claim 11, wherein enabling a recording comprises:
recording by a first user a context-specific first recording; and
recording by a second user a context-specific second recording,
wherein the context-specific first recording and the context-specific second recording are recorded within a predetermined time frame.

13. The method of claim 11, wherein enabling a recording of one or more custom messages comprises recording individual context specific recordings by a plurality of different users.

14. The method of claim 11, further comprising altering the recording of the one or more custom messages by executing one or more audio and video processing functions.

15. Then method of claim 12, further comprising:
automatically concatenating the context-specific first recording and the context specific second recording into a combined media file.

16. The method of claim 14, wherein the one or more audio and video processing functions include parsing a media file to extract snippets of a recording.

17. An electronic greeting card product, comprising:
means for altering a context-specific first recording by a first user;
means for altering a context-specific second recording by a second user; and
generating means to create a media file concatenated from the recording of at least a first portion of the context-specific first recording and a portion of the context-specific second recording.

18. The electronic greeting card product of claim 17, further comprising:
means for altering the media file using at least one of audio and video processing techniques.

19. The electronic greeting card product of claim 18, where the audio and video processing function include parsing a media file to extract snippets of a recording.

20. The electronic greeting card product of claim 19, further comprising:
a user interface configured to enable a user selection from a collection of predefined structured context-specific media templates; and
customize a recorded message.
